(19) United States
(12) Patent Application Publication
(10) Pub. No.: US 2024/0147149 A1
(43) Pub. Date: May 2, 2024

(54) ACOUSTIC DEVICE, AND ELECTRONIC DEVICE

(71) Applicant: CASIO COMPUTER CO., LTD., Tokyo (JP)

(72) Inventors: Hiroki NISHIYAMA, Fussa-shi, Tokyo (JP); Hiroaki OTSUBO, Higashimurayama-shi, Tokyo (JP)

(73) Assignee: CASIO COMPUTER CO., LTD., Tokyo (JP)

(21) Appl. No.: 18/279,005

(22) PCT Filed: Jan. 5, 2022
(86) PCT No.: PCT/JP2022/000053

§ 371 Date: Aug. 25, 2023

(30) Foreign Application Priority Data
Feb. 25, 2021 (JP) 2021-028412

(51) Int. Cl. H04R 1/44; H04R 1/02

(52) U.S. Cl. CPC H04R 1/44; H04R 1/02; H04R 2400/11; H04R 2499/11

(57) ABSTRACT

An acoustic device including: a vibrating film which has waterproofness; a support which is located alongside the vibrating film in a direction and supports the vibrating film; a waterproof which is in contact with the support; an insulating plate which is located on an opposite side of the waterproof to a side where the support is arranged, and which has a first through hole leading to the vibrating film; and a metal plate which is located on an opposite side of the insulating plate to the waterproof, which has a second through hole communicating with or containing the first through hole, and which is fixed in a state pressing the insulating plate along the direction.

### TECHNICAL FIELD

The present invention relates to an acoustic device and an electronic device.

### BACKGROUND ART

Portable, body-worn electronic devices are used in a variety of environments. When this electronic device is also used underwater, and the like, it is required to be waterproof. Patent document 1 discloses a technology for isolating a speaker from the outside and ensuring waterproofness by holding a support bonded with an adhesive to a waterproof vibrating film with a waterproof packing.

### CITATION LIST

### Patent Literature

Patent Document 1: JP 2018-107503A

### SUMMARY OF INVENTION

### Technical Problem

However, when more reliable waterproofing is required, when the waterproof packing is directly pressed with a sheet metal member, there is a problem that it is difficult to obtain sufficient waterproofness even under higher water pressure than before.

An object of the present invention is to provide an acoustic device and an electronic device capable of obtaining sufficient waterproof performance under higher water pressure than before.

### Solution to Problem

In order to achieve the above object, the present invention includes an acoustic device including:
a vibrating film which has waterproofness;
a support which is located alongside the vibrating film in a direction and supports the vibrating film;
a waterproof which is in contact with the support;
an insulating plate which is located on an opposite side of the waterproof to a side where the support is arranged, and which has a first through hole leading to the vibrating film; and
a metal plate which is located on an opposite side of the insulating plate to the waterproof, which has a second through hole communicating with or containing the first through hole, and which is fixed in a state pressing the insulating plate along the direction.

### BRIEF DESCRIPTION OF DRAWINGS

FIG. 1 This is a partial cross-sectional view showing the vicinity of an acoustic device in an electronic device of the present embodiment.

FIG. 2 This is a diagram explaining a waterproof structure.

FIG. 3 This is a diagram explaining the positional relationship of conductor parts.

### DESCRIPTION OF EMBODIMENTS

Hereinafter, an embodiment of the present invention is explained based on drawings.

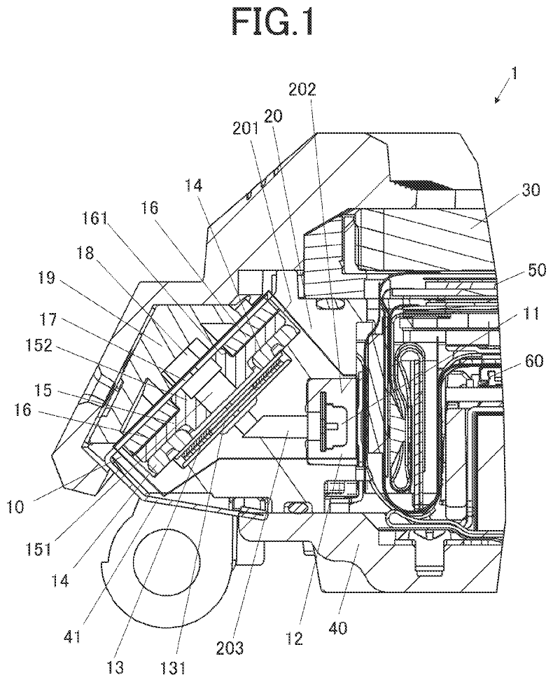

FIG. 1 is a partial cross-sectional view showing the vicinity of an acoustic device 10 in an electronic device 1 of the present embodiment.

The electronic device 1 is, for example, an electronic wristwatch and includes a housing 20, a windshield glass 30, a back cover 40, a display screen 50, an operation part 60, the acoustic device 10, and the like.

The housing 20 is a cylindrical member with the top and bottom open. The housing 20 seals the display screen 50 and the operation part 60 internally by covering the upper side where the display screen 50 is located with the windshield glass 30 and the lower side with the back cover 40.

The windshield glass 30 is a transparent member, for example, glass. The back cover 40 is a conductive member (conductor). Here, the housing 20 is a dielectric such as resin.

The display screen 50 is, for example, a liquid crystal display screen, and the display contents can be viewed from the outside via the windshield glass 30. The operation part 60 has a CPU, RAM, and the like, and controls various operations of the electronic device 1. Also, batteries, and the like are stored in a space sealed by the housing 20, windshield glass 30, and back cover 40.

The electronic device 1 may have an exterior member such as a bezel on the outside of the housing 20. The exterior member can be used to mitigate external impacts or as decorations.

The acoustic device 10 is a device that outputs or detects sound, that is, a speaker or microphone.

The acoustic device 10 includes an acoustic converter 11 (acoustic module), a rubber edge 12, an acoustic transmission part 13, a waterproof packing 14 (waterproof), a sound hole case 15 (insulating plate), a compression plate 16 (metal plate), a dustproof plate 17 (metal plate), screws 18, an exterior member 19, and the like.

The housing 20 has a recess 201 on the outside and a recess 202 on the inside. Of the acoustic device 10, the acoustic converter 11 and the rubber edge 12 are located in the recess 202 of the housing 20, and the acoustic transmission part 13, waterproof packing 14, and the like are contained in the recess 201. The recesses 201, 202 are communicated by an air passage 203. The air passage 203 may be bent along the way.

The acoustic converter 11 is a speaker or microphone (collectively described as a conversion element) that converts between sound (sound waves) and electrical signals. The rubber edge 12 is located around the conversion element of the acoustic converter 11.

The acoustic transmission part 13 has a vibrating film 131. The vibrating film 131 is a conventionally known thin film member that vibrates in response to sound waves and transmits sound from one side to the other across the vibrating film 131. Also, the vibrating film 131 has waterproofness. In other words, the vibrating film 131 does not allow water to pass through at a water pressure within the reference range and is not destroyed or irreversibly deformed. Thus, the vibrating film 131 prevents water from entering the air passage 203 and the acoustic converter 11 from the outside. The periphery of the vibrating film 131 is supported in an annular shape by a support 133 on both sides. The support 133 has an opening in line with the central part of the vibrating film 131. The vibrating film 131 can vibrate inside being supported in an annular shape by the support 133.

The waterproof packing 14 is an O-ring located in an annular shape along the periphery of the acoustic transmission part 13. The waterproof packing 14 is shaped according to the outer circumference shape of the acoustic transmission part 13 and is one size larger than the acoustic transmission part 13. The waterproof packing 14 prevents water from entering the interior (side of the acoustic converter 11) through a gap at the periphery of the acoustic transmission part 13.

The sound hole case 15 has an air passage 151 (first through hole) penetrating the center and leading to the vibrating film 131. The sound hole case 15, for example, is formed by resin, but if it is not a conductor metal, it may be formed by ceramic, and the like, or it may be a composite member combining these multiple insulating members. The sound hole case 15 is located on the outside of the waterproof packing 14, that is, on the opposite side of the waterproof packing 14 to the side where the support 133 (acoustic transmission part 13) is arranged. The inside of the sound hole case 15 (side of the waterproof packing 14) is one step lower in an annular shape so that the waterproof packing 14 fits, and the outside has a protrusion 152 through which the air passage 151 penetrates in the center. The compression plate 16 is fitted in an annular shape around the protrusion 152. That is, the sound hole case 15 (insulating plate) does not have to be flat.

The compression plate 16 is a metal plate that presses to fix the waterproof packing 14 (sound hole case 15) by being fixed to the housing 20 by the screws 18. The compression plate 16 has a through hole 161 (second through hole). The through hole 161 has a larger cross-sectional size than the air passage 151, and the protrusion 152 of the sound hole case 15 is inserted (contained) inside the through hole 161. The compression plate 16 is larger in plane view than the sound hole case 15, and since both ends and the like are fixed with the screws 18, the waterproof packing 14 can be uniformly pressed to be fixed.

The dustproof plate 17 has a fine opening or mesh at least according to the position of the air passage 151. The dustproof plate 17 is a metal plate, for example, stainless steel (SUS), and is fixed to the housing 20 by the screws 18 together with the compression plate 16. The opening or mesh suppresses the entry of garbage or dust from the outside while allowing sound to pass through. The dustproof plate 17 is electrically connected to the back cover 40 by a metal line 41, and both the dustproof plate 17 and the compression plate 16 in contact with the dustproof plate 17 are housing grounded.

As described above, the screw 18 is a small screw (screw) that collectively fixes the compression plate 16 and the dustproof plate 17 to the housing 20 in an overlapping state. The number of screws is not particularly limited but is determined according to the size of the space and the certainty of fixation, and the number of screws is, for example, 2.

The exterior member 19 is a cover member covering the opening part of the dustproof plate 17 and may have an appropriate shape according to the external design. The exterior member 19 is, for example, various resins.

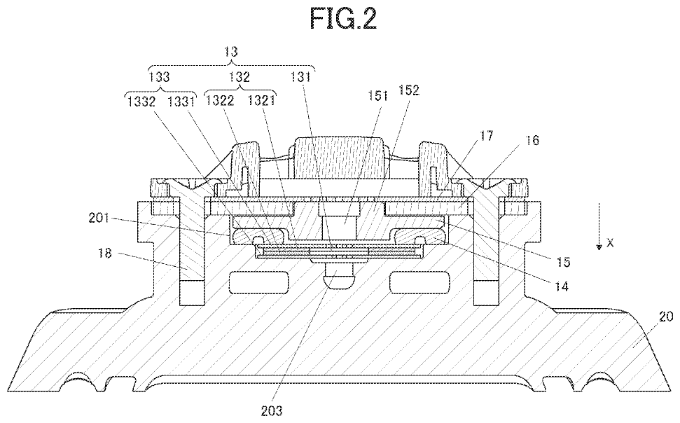

FIG. 2 is a diagram explaining the waterproof structure. Sound (sound waves) transmitted from the outside to the air passage 151 or sound (sound waves) transmitted from the acoustic converter 11 to the air passage 203 reaches the acoustic transmission part 13. Sound waves arriving at the vibrating film 131 vibrate the vibrating film 131, and sound waves corresponding to the vibration of the vibrating film 131 are further output to the opposite side to the arrival side, here in a direction along the X axis (a direction). In other words, the X-axis direction is perpendicular to the vibrating film 131 in a static state with no sound at atmospheric pressure.

In addition to the vibrating film 131, the acoustic transmission part 13 has supports 1331, 1332 (collectively support 133) arranged in the X direction alongside the vibrating film 131 and located on both sides thereof, and has adhesive tapes 1321, 1322 (collectively adhesive tape 132) for bonding the vibrating film 131 to the supports 1331, 1332, respectively. In other words, the acoustic transmission part 13 is integrated in the order of the support 1332, the adhesive tape 1322, the vibrating film 131, the adhesive tape 1321, and the support 1331 in order from the inside. The vibrating film 131 and adhesive tape 132 may be one size smaller than the support 133. The size of the vibrating film 131 need not be the same as the size of the adhesive tape 132.

As described above, the vibrating film 131 transmits sound to the opposite side of the vibrating film 131 by vibrating the central part of the vibrating film 131 in air. Underwater, the vibrating film 131 prevents water from entering the side of the acoustic converter 11 from the outside.

The support 133 is a metal plate and supports the periphery of the vibrating film 131 by holding it from both sides. The support 133 does not have to be a single member, or it may be multiple members integrated.

The adhesive tape 132 bonds the vibrating film 131 to the support 133 in an annular shape in the support part of the support 133. Although not particularly limited, since the central part which the adhesive tape 132 does not bond to the vibrating film 131 is circular, the vibrating film 131 easily vibrates appropriately and also makes it easier for stress on the bonded part of the vibrating film 131 to be evenly distributed even when water pressure is applied to the vibrating film 131. The adhesive tape 132 is a double-sided tape having at least one layer of adhesive on both sides of a sheet-like base material. The adhesive has elasticity at least in the expected pressure range, and is elastically deformed, that is, compressed, at a ratio corresponding to the magnitude of the pressure. The thickness of the adhesive tape 132 at about air pressure is equal to or greater than the thickness where the support 133 does not interfere with the vibration of the vibrating film 131.

The adhesive tape 132 may not completely bond and fix the vibrating film 131 to the support 133 like the adhesive if it has about the same degree of elasticity as the adhesive and can ensure waterproofness and it can suppress misalignment of the vibrating film 131 with respect to the support 133, especially misalignment in a direction perpendicular to the X direction when water pressure is applied, and a sticky member may be located between the vibrating film 131 and the support 133.

As described above, the dustproof plate 17 and the compression plate 16 are fixed by the screws 18. When the screws 18 are strongly tightened, the compression plate 16 is pressed. In response to this pressing, the sound hole case 15 and the waterproof packing 14 are further pushed down along the X direction, and the waterproof packing 14 prevents water from entering the acoustic transmission part 13 while pressing the acoustic transmission part 13. When having a waterproof function higher (for example, about a pressure of 10 to 20 atmospheres) than simple daily waterproofing (about a pressure of several atmospheres), if the sound hole case 15 is a metal member, the pressure necessary to completely fill the space between the waterproof packing 14 and the housing 20 and the support 133 even under high water pressure is not applied, and it is difficult to obtain necessary waterproofness. On the other hand, even if only the sound hole case 15 is directly fixed with the screw 18, pressure is relieved (especially when rigidity is significantly lower (elastic modulus is not very high) compared to metal members, and the like, such as resin members), sufficient pressure is not applied to the waterproof packing 14. In the electronic device 1, the waterproof packing 14 is deformed to fill the gap with the housing 20 and the acoustic transmission part 13, and waterproofness is ensured by selectively and more reliably pressing the range of the waterproof packing 14 against the sound hole case 15 with the compression plate 16 which is a metal plate with higher rigidity (larger elastic modulus) than the sound hole case 15. In particular, since the compression plate 16 is located to include the entire range of the waterproof packing 14 in plane perspective seen along the X direction, it is possible to seal the gap by effectively pressing, by the surface, the range where the waterproof function occurs. The screw 18 may be tightened with strength corresponding to the required waterproof performance.

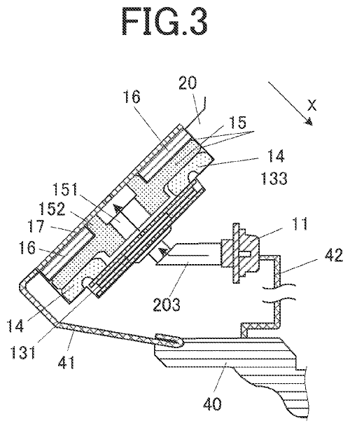

FIG. 3 is a diagram explaining the positional relationship of conductor parts.

As described above, the dustproof plate 17, which is a conductor, and the compression plate 16 in contact with the dustproof plate 17 are connected to the back cover 40 by the metal line 41, so that they are housing grounded. Meanwhile, the acoustic converter 11 is housing grounded to the back cover 40 via a conductor path 42 inside the housing 20. Therefore, in a normal state, the compression plate 16, the dustproof plate 17, and the acoustic converter 11, together with the back cover 40, are maintained equally at an approximate ground voltage. Also, the support 133 is not connected to another conductor here and is in a float state.

However, in a portable electronic device 1, due to the design of compactly wiring each configuration, the metal line 41 or conductor path 42 do not necessarily have a sufficient cross-sectional area, and there are cases where they become longer compared to the linear distance. Also, the potential of a housing such as the back cover 40 is not an accurate ground potential when the back cover 40, and the like, is not electrically connected to the ground via a human body, and the like, and depending on the situation, it is possible that the housing may be charged.

In such a situation, when connected to the ground, the housing ground voltage changes (drops) rapidly. There are cases where a short-term potential difference occurs between the dustproof plate 17 and the compression plate 16 and the acoustic converter 11 in response to differences in resistance, parasitic capacity, and the like according to the length and cross-sectional area of the metal line 41 and the conductor path 42. At this time, when the distances between the acoustic converter 11 and the dustproof plate 17 and the compression plate 16 via the air passages 203, 151, in particular, here, the distance between each and the support 133 since the support 133 is sandwiched therebetween, are both too short (if only one distance is short, the problem is unlikely to occur since the support 133 floats as described above and no current flows), as shown by the arrow in FIG. 3, the discharge via the support 133 may occur in the air passages 203, 151.

Instantaneous generation of large current due to discharge may mainly damage the acoustic converter 11 (in particular, a digital microphone, and the like). As described above, in the electronic device 1 equipped with the acoustic device 10 having a waterproof function at high pressure, the compression plate 16 is required, but the compression plate 16 is structured so that the distance between the compression plate 16 and the support 133 is not greatly reduced compared to the dustproof plate 17.

Here, as described above, the sound hole case 15, which is an insulating member, is located between the compression plate 16 and the support 133, so that the compression plate 16 and the support 133 are separated, and discharge is suppressed. In particular, since the sound hole case 15 has a protrusion 152 and the compression plate 16 is located outside of it, the compression plate 16 is structured so that the compression plate 16 does not face the air passage 203. Thus, the distance between the support 133 and the conductor part does not shrink from the distance between the support 133 and the dustproof plate 17 that has originally existed, and discharge is suppressed more effectively. In other words, the sound hole case 15 functions as a spacer member between the support 133 and the compression plate 16 and the dustproof plate 17.

As described above, the acoustic device 10 of the present embodiment includes: the vibrating film 131 which has waterproofness; the support 133 which is located alongside the vibrating film 131 in the X direction and supports the vibrating film 131; the waterproof packing 14 in contact with the support 133; the sound hole case 15 of an insulating member located on the opposite side of the waterproof packing 14 to the side where the support 133 is arranged and has the air passage 151; and the metal compression plate 16 which is located on the opposite side of the sound hole case 15 to the waterproof packing 14, has the through hole 161 communicating with or containing the air passage 151, and is fixed in a state pressing the sound hole case 15 along the X direction.

Thus, by pressing down the waterproof packing 14 with two layers of the sound hole case 15, which is an insulating member which is not a metal, and the metal compression plate 16, the waterproof packing 14 can be pushed in more stably and strongly. Thus, the acoustic device 10 can more reliably and sufficiently waterproof the internal acoustic converter 11 even under higher water pressure than before.

Also, since the sound hole case 15, which is an insulating member, is placed in contact with the waterproof packing 14, and is further pushed down by the metal compression plate 16, the compression plate 16 and the support 133 can be separated. Thus, discharge between the compression plate 16 and the support 133 can be reduced.

Also, the sound hole case 15 has the protrusion 152 through which the air passage 151 penetrates. The through hole 161 contains the protrusion 152 inside. In this way, by the double structure in which the compression plate 16 does not directly face the air passage 151, discharge is suppressed more reliably. Also, alignment during manufacturing and assembly is also easy, and waterproof strength can be enhanced more easily and reliably.

Also, the compression plate 16 includes the entire waterproof packing 14 in plane perspective seen along the X direction. Therefore, the waterproof packing 14 can be evenly and reliably pressed to enhance waterproofness.

Also, the compression plate 16 is fixed by the screws 18. Since the pressing strength is fixed by the tightness of the screws 18, desired waterproof strength can be easily obtained reliably and stably.

Also, the adhesive tape 132 is located between the support 133 and the vibrating film 131. Alternatively, a sticky member may be located in place of this adhesive tape 132. By fixing the vibrating film 131 to the support 133 or at least suppressing relative movement, waterproofness between the support 133 and the vibrating film 131 can be obtained more reliably.

Also, the sound hole case 15 is formed by resin or ceramic. Since the sound hole case 15 is not a metal member, but formed by resin or ceramic in particular, the gap between the sound hole case 15 and the waterproof packing 14 is filled more appropriately according to water pressure when water pressure is applied, and the space between the waterproof packing 14 and the housing 20 is also filled to ensure waterproofness.

Also, the electronic device 1 of the present embodiment includes the acoustic device 10 described above and the housing 20 to which the compression plate 16 is fixed. Since the electronic device 1 can reliably obtain waterproofness under higher water pressure than before, the electronic device 1 can be used in more diverse and severe environments.

Also, the acoustic device 10 includes the acoustic converter 11 for converting sound waves and electrical signals. The acoustic converter 11 is waterproofed by the vibrating film 131 and the waterproof packing 14, and the compression plate 16 and the acoustic converter 11 are each housing grounded to the back cover 40.

In the small electronic device 1, the ground path is thin, and it often extends while avoiding other wiring and configurations. Also, there are cases where the housing ground voltage itself does not become zero. As a result, when a potential difference occurs between configurations due to a rapid change in housing ground voltage, and the like, discharge occurs between nearby configurations compared to the ground path, causing serious damage to electronic components. Since the electronic device 1 of the present embodiment can further improve waterproofness while preventing the occurrence of such a discharge path, a more robust electronic device 1 can be obtained, thereby making it possible to use the electronic device 1 under more diverse conditions.

The present invention is not limited to the embodiments described above, and various modifications are possible.

For example, in the above embodiment, it was explained that the through hole 161 of the compression plate 16 does not face the air passage 151, but if a distance from the support 133 can be obtained, they may face slightly.

Also, the sound hole case 15 was explained as having a stepped annular protrusion 152, but the sound hole case 15 is not limited to this. For example, the sound hole case 15 may be in a shape in which the air passage 151 is located at the center where the sound hole case 15 tapers down, and in this case, the shape of the through hole 161 is also in line with the shape of this sound hole case 15.

Also, in the above embodiment, it was explained that the screws 18 fix the dustproof plate 17 and the compression plate 16, but the fixing is not limited to these. It is sufficient that the compression plate 16 is fixed so as to appropriately press the sound hole case 15. For example, the screw 18 may press the compression plate 16 alone, or pressing may be performed with something other than the screw.

Also, the shapes of the air passages 203, 151 are not limited to those shown in the above embodiments. The thickness, bending, and the like may be adjusted according to the shape of the electronic device 1 and the housing 20 and the positional relationship with other parts, and the like.

Also, in the above embodiment, it was explained that the compression plate 16 includes the entire range of the waterproof packing 14 in plane perspective, but as long as the waterproof packing 14 is reliably pressed, the compression plate 16 is not limited to this. Also, the compression plate 16 may be a combination of multiple sheets (2 sheets, and the like) of sheet metal, and the like.

Also, in the above embodiment, an electronic wristwatch was given as an example as the electronic device 1 and explained, but the electronic device 1 is not limited to this. The electronic device 1 may be another electronic device.

In addition, specific details such as configuration, structure, materials, and the like shown in the above embodiment can be appropriately changed to the extent that they do not deviate from the main points of the present invention.

Several embodiments of the present invention have been explained, but the scope of the present invention is not limited to the embodiments described above and includes the scope of the invention described in the claims and the equivalent scope thereof.

### INDUSTRIAL APPLICABILITY

This invention can be used for acoustic devices and electronic devices.

1. An acoustic device comprising:
a vibrating film which has waterproofness;
a support which is located alongside the vibrating film in a direction and supports the vibrating film;
a waterproof which is in contact with the support;
an insulating plate which is located on an opposite side of the waterproof to a side where the support is arranged, and which has a first through hole leading to the vibrating film; and
a metal plate which is located on an opposite side of the insulating plate to the waterproof, which has a second through hole communicating with or containing the first through hole, and which is fixed in a state pressing the insulating plate along the direction.

2. The acoustic device according to claim 1, wherein
the insulating plate includes a protrusion through which the first through hole penetrates, and
the second through hole contains the protrusion inside.

3. The acoustic device according to claim 1, wherein the metal plate includes the entire waterproof in a plane perspective seen along the direction.

4. The acoustic device according to claim 1, wherein the metal plate is fixed by a screw.

5. The acoustic device according to claim 1, wherein an adhesive or a sticky member is located between the support and the vibrating film.

6. The acoustic device according to claim 1, wherein the insulating plate is formed by resin or ceramic.

7. An electronic device comprising:
the acoustic device according to claim 1; and
a housing to which the metal plate is fixed.

8. The electronic device according to claim 7, wherein
the acoustic device includes an acoustic converter which converts between a sound wave and an electrical signal,
the acoustic converter is waterproofed by the vibrating film and the waterproof, and
each of the metal plate and the acoustic converter is housing grounded.
